(19) United States
(12) Patent Application Publication
(10) Pub. No.: US 2026/0213265 A1
(43) Pub. Date: Jul. 23, 2026

(54) LITHIUM ION BATTERY COMPRISING A NON-AQUEOUS ELECTROLYTE AND APPLICATION

(71) Applicant: NANO AND ADVANCED MATERIALS INSTITUTE LIMITED, HONG KONG (CN)

(72) Inventors: Qiuhong WANG, HONG KONG (CN); Lang WANG, HONG KONG (CN); Shengbo LU, HONG KONG (CN); Cuili ZHANG, HONG KONG (CN); Soon Yee LIEW, HONG KONG (CN); Wing Lung HON, HONG KONG (CN); Chenmin LIU, HONG KONG (CN)

(73) Assignee: NANO AND ADVANCED MATERIALS INSTITUTE LIMITED, HONG KONG (CN)

(21) Appl. No.: 19/370,805

(22) Filed: Oct. 28, 2025

Related U.S. Application Data
(60) Provisional application No. 63/748,956, filed on Jan. 23, 2025.

(51) Int. Cl. H01M 10/0567; H01M 10/0525; H01M 10/0569

(52) U.S. Cl. CPC H01M 10/0567; H01M 10/0525; H01M 10/0569; H01M 2300/0034; H01M 2300/004

(57) ABSTRACT

The present disclosure provides a lithium-ion battery comprising a non-aqueous electrolyte, wherein the non-aqueous electrolyte comprises: (1) 5-30 wt % of a fluorinated co-solvent; (2) 0.1-2 wt % of an unsaturated siloxane, a saturated siloxane and/or a triazine compound; and (3) 1-15 wt % of a combination of fluoroethylene carbonate and di-fluoroethylene carbonate as a film-forming additive. The lithium-ion battery possesses a high thermal stability and fast-charging ability. The present disclosure also provides use of an unsaturated siloxane, a saturated siloxane and/or a triazine compound as a scavenger in a non-aqueous electrolyte for a lithium-ion battery. With such compounds, trace water and HF generated by the side reaction under high temperature can be scavenged from the non-aqueous electrolyte.

### CROSS-REFERENCE TO RELATED APPLICATION

This application claims the priority benefit of U.S. provisional application Ser. No. 63/748,956, filed on Jan. 23, 2025. The entirety of the above-mentioned patent application is hereby incorporated by reference herein and made a part of specification.

### BACKGROUND

### Technical Field

The present disclosure relates to the field of lithium ion batteries. More particularly, it relates to a lithium ion battery comprising a non-aqueous electrolyte and its application.

### Description of Related Art

The rapid development of new energy vehicles has made lithium-ion battery technology be a core component of electric vehicles, with high-energy-density batteries being a critical direction for future advancements. Using high-nickel-content cathode active materials (Ni>0.8) and introducing silicon into the anode mix are rational material approaches to achieving higher energy density in lithium-ion batteries. Currently, several issues have been exposed during the operation of electric vehicles, such as rapid capacity decay, short lifespan, and long charging time. These issues are closely related to the poor high-temperature stability of high-energy-density high-nickel ternary materials and silicon-based materials, the expansion of silicon-based materials, and poor lithium-ion kinetics at the interface. Battery performance is strongly influenced by electrolytes. Traditional electrolytes typically focus on improving fast-charging performance by enhancing ionic conductivity, which is often achieved by using low-molecular-weight solvents such as carboxylic esters (e.g., ethyl acetate). However, such solvents are unstable in high-nickel-silicon systems and exhibit poor high-temperature performance. Additionally, traditional electrolytes often use scavengers like Tris(trimethylsilyl) phosphate to eliminate hydrofluoric acid and water molecules generated at high temperatures. However, these scavengers are incompatible with the most commonly used additives for silicon-based batteries, FEC (fluoroethylene carbonate), and can catalyze its decomposition, leading to acid production.

Thus, a lithium-ion battery with a high thermal stability and fast-charging ability is necessary in the art.

### SUMMARY

The present disclosure seeks to address the drawbacks of lithium-ion batteries in the prior art. The inventors proposed a lithium-ion battery comprising a non-aqueous electrolyte, which comprises a fluorinated co-solvent, a scavenger of an unsaturated siloxane, a saturated siloxane and/or a triazine compound, and a film-forming additive of di-fluoroethylene carbonate (DiFEC); and thereby achieved the present disclosure.

In a first aspect of the present disclosure, provided is a lithium-ion battery comprising a non-aqueous electrolyte, wherein the non-aqueous electrolyte comprises:
(1) 5-30 wt % of a fluorinated co-solvent;
(2) 0.1-2 wt % of an unsaturated siloxane, a saturated siloxane and/or a triazine compound; and
(3) 1-15 wt % of a combination of fluoroethylene carbonate and di-fluoroethylene carbonate as a film-forming additive.

In a second aspect of the present disclosure, provided is use of an unsaturated siloxane, a saturated siloxane and/or a triazine compound as a scavenger in a non-aqueous electrolyte for a lithium-ion battery, wherein,
the unsaturated siloxane is represented by formula IV:

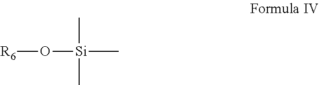

wherein R₆ is a C2-C4 hydrocarbyl group with at least one unsaturated carbon-carbon double or triple bond;
the saturated siloxane is represented by any one of formulae V and VI:

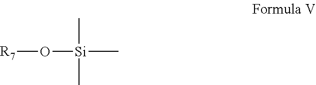

wherein R₇ is a C1-C6 saturated hydrocarbyl group;

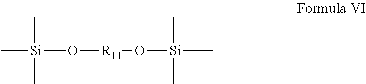

wherein R₁₁ is an optionally substituted C1-C6 alkylene; and
the triazine compound is represented by formula VII:

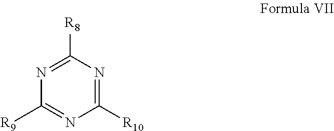

wherein R₈, R₉ and R₁₀ are each independently a C1-C4 hydrocarbyl group.

The present disclosure provides a lithium-ion battery comprising a non-aqueous electrolyte, which comprises a fluorinated co-solvent, a scavenger of an unsaturated siloxane, a saturated siloxane and/or a triazine compound, and a film-forming additive of di-fluoroethylene carbonate. The fluorinated reagent is designed as a co-solvent to reduce the de-solvation energy of the electrolyte, and an electrolyte additive is introduced to enhance lithium-ion diffusion at the interphases, thereby improving fast-charging performance. The inventors found that introduction of di-fluoroethylene carbonate to replace fluoroethylene carbonate partially can repair solid electrolyte interface (SEI) on silicon particles; and introduction of the unsaturated siloxane, e.g., propargyloxy trimethylsilane (PMSL), the saturated siloxane, e.g., trimethyl(propoxy) silane (TMSL) or 2,2,7,7-tetramethyl-3,6-dioxa-2,7-disilaoctane-4,4,5,5-tetracarbonitrile (TDSTCN), and/or the triazine compound, e.g., triallyl cyanurate (TAC), can scavenge trace water and HF generated by the side reaction under high temperature in non-aqueous electrolyte, thus effectively improving capacity retention at high temperature. More importantly, the combination of the fluorinated co-solvent, the siloxane (unsaturated and/or saturated) and/or the triazine compound, and the di-fluoroethylene carbonate in the non-aqueous electrolyte can promote the fast-charging ability and thermal stability of the lithium-ion battery.

### BRIEF DESCRIPTION OF THE DRAWINGS

The accompanying drawings are included to provide a further understanding of the disclosure and are incorporated in and constitute a part of this specification. The drawings described herein are for illustration purposes only and are not intended to limit the scope of the disclosure in any way.

FIG. 1 illustrates color changes for the non-aqueous electrolytes prepared according to Comp. 3, Comp. 4 and Exp. 1 left at room temperature overnight.

FIG. 2 illustrates color changes for the non-aqueous electrolytes prepared according to Comp. 3, Comp. 4 and Exp. 1 after storage at 55° C. for 5 days.

FIG. 3 illustrates the structures of the lab-made winding pouch cell.

FIG. 4 illustrates state of health (SOH) for the cells with the non-aqueous electrolytes prepared according to Comp. 3, Comp. 4, Exp. 1, Exp. 6, Exp. 7 and Exp. 8 after storage at 55° C. for 30 day, respectively.

FIG. 5 illustrates thermochemistry theory for calculating conventional solvation free energy.

FIG. 6 illustrates the charging capacity of cells with different electrolytes of Exp. 1, Comp. 1 and Comp. 2 at 1C, 2C, 3C and 4C charging.

FIG. 7 illustrates the charging capacity of cells with different electrolytes of Exp. 2, Exp. 3, Exp. 4, Exp. 5 and Comp. 2 at 3C and 4C charging.

FIG. 8 illustrates the X-ray photoelectron spectroscopy (XPS) spectrum of etched anode SEI by using a) electrolyte Comp. 1 (without DiFEC) and b) electrolyte Exp. 1 (with DiFEC).

FIG. 9 illustrates the intensity ratios of the inorganic component (LiF intensity by XPS at 686-687 nm) over the organic component (C—O intensity by XPS at 286-287 nm) for the SEIs of the cells with electrolytes of Exp. 1 and Comp. 1.

### DESCRIPTION OF THE EMBODIMENTS

The following detailed description is merely exemplary in nature and is in no way intended to limit the present disclosure or its application or uses.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard variation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

The terminology used herein is for the purpose of describing particular example embodiments only and is not intended to be limiting.

As used herein, “a”, “an”, “the”, “at least one” and “one or more” are used interchangeably to indicate that at least one of the specified elements, materials, ingredients or method steps is present, unless the context clearly indicates otherwise.

As used herein, the expressions “a/the first”, “a/the second”, “a/the third” and the like are only for the purpose of distinction, but do not seek to define any order, priority, or grade.

As used herein, the terms “about” and “substantially” are used herein with respect to measurable values and ranges due to expected variations known to those skilled in the art (e.g., limitations and variability in measurements). The term “about” also indicates that the stated numerical value allows some slight imprecision (with some approach to exactness in the value; approximately or reasonably close to the value; nearly). If the imprecision provided by the term “about” is not otherwise understood in the art with this ordinary meaning, then the term “about” as used herein indicates at least variations that may arise from ordinary methods of measuring and using such parameters. In addition, disclosure of ranges includes disclosure of all values and further divided ranges within the entire range.

As used herein, the term “including”, “containing” and the like terms, together with their grammatical variations, are synonymous with the term “comprising” and its grammatical variations. The term “comprising” and its grammatical variations are open-ended and shall be understood in the context of the present disclosure to include not only the specified elements, materials, ingredients or method steps, but also additional unspecified elements, materials, ingredients or method steps.

As used herein, the term “consisting of” and its grammatical variations should be understood in the context of the present disclosure to exclude the presence of any unspecified element, ingredient or method step. As used herein, the term “consisting essentially of” and its grammatical variations should be understood in the context of the present disclosure to include the specified elements, materials, ingredients or method steps and those that do not materially affect the basic and novel characteristic(s) of what is being described. It shall be understood that, when the term “comprising” and its grammatical variations are used and no additional elements, materials, ingredients or method steps that may materially affect the basic and novel characteristic(s) of what is being described are included, then the term “comprising” can be replaced with the term “consisting of” or “consisting essentially of” and their grammatical variations.

Whereas specific aspects of the disclosure are going to be described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the disclosure which is to be given the full breadth of the claims appended and any and all equivalents thereof.

As mentioned above, the present disclosure aims to provide a lithium-ion battery with a high thermal stability and fast-charging ability.

In a first aspect of the present disclosure, provided is a lithium-ion battery comprising a non-aqueous electrolyte, wherein the non-aqueous electrolyte comprises:
(1) 5-30 wt % of a fluorinated co-solvent;
(2) 0.1-2 wt % of an unsaturated siloxane, a saturated siloxane and/or a triazine compound; and
(3) 1-15 wt % of a combination of fluoroethylene carbonate and di-fluoroethylene carbonate as film-forming additives.

In the context of the present disclosure, a fluorinated co-solvent is selected to lower the de-solvation energy, so as to improve the high-rate capacity of the lithium-ion battery.

In a particular embodiment, the fluorinated co-solvent may be 5, 6, 7, 8, 9, 10, 11, 12, 13, 14, 15, 16, 17, 18, 19, 20, 21, 22, 23, 24, 25, 26, 27, 28, 29 or 30 wt % or in any range composed of the above numbers, with respect to total weight of the non-aqueous electrolyte.

In a preferred embodiment, the fluorinated co-solvent may be 15-25 wt %, with respect to total weight of the non-aqueous electrolyte.

In a further particular embodiment, the fluorinated co-solvent may be selected from a compound represented by any one of Formulas I-III:

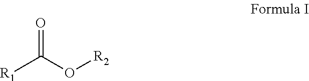

wherein R₁ is a C1-C4 hydrocarbyl or fluorohydrocarbyl group; R₂ is a C1-C4 hydrocarbyl or fluorohydrocarbyl group; and at least one of R₁ and R₂ contains a fluorine atom;

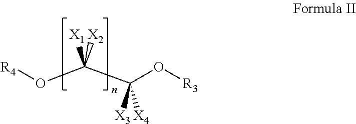

wherein n is any integer from 1 to 4, R₃ is a C1-C4 hydrocarbyl or fluorohydrocarbyl group; R₄ is a C1-C3 hydrocarbyl or fluorohydrocarbyl group, and at least one of R₃ and R₄ contains a fluorine atom; X₁ to X₄ are independently selected from hydrogen, halogen, or C1-C3 hydrocarbyl or C1-C3 fluorohydrocarbyl group;

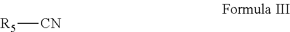

wherein R₅ is a C1-C4 fluorohydrocarbyl group.

In the context of the present disclosure, the term “C1-C4 hydrocarbyl group” means alkyl, alkenyl or alkynyl groups with 1-4 (1, 2, 3 or 4) carbon atoms, including, for example, but not limited to, methyl, ethyl, propyl, butyl, isobutyl, vinyl, propenyl, butenyl, isobutenyl, ethynyl, propynyl, or butynyl.

In the context of the present disclosure, the term “C1-C3 hydrocarbyl group” means alkyl, alkenyl or alkynyl groups with 1-3 (1, 2 or 3) carbon atoms, including, for example, but not limited to, methyl, ethyl, propyl, vinyl, propenyl, ethynyl, or propynyl.

In the context of the present disclosure, the term “C1-C4 fluorohydrocarbyl group” means a C1-C4 hydrocarbyl group (as defined above) with at least one hydrogen substituted with fluorine. For example, C1-C4 fluorohydrocarbyl group may be, but is not limited to, fluoromethyl, difluoromethyl, trifluoromethyl, tetrafluoromethyl, fluoroethyl, 1,1-difluoroethyl, 1,2-difluoroethyl, 1-fluoropropyl, 2-fluoropropyl, 1-fluorobutyl, 2-fluorobutyl, 1-fluoroisobutyl, 2-fluoroisobutyl, 1-fluorovinyl, 1-fluoropropenyl, 2-fluoropropenyl, 1-fluorobutenyl, 2-fluorobutenyl, 1-fluoroisobutenyl, 2-fluoroisobutenyl, 1-fluoroethynyl, 1-fluoropropynyl, 2-fluoropropynyl, 1-fluorobutynyl or 2-fluorobutynyl.

In the context of the present disclosure, the term “C1-C3 fluorohydrocarbyl group” means a C1-C3 hydrocarbyl group (as defined above) with at least one hydrogen substituted with fluorine. For example, C1-C3 fluorohydrocarbyl group may be, but is not limited to, fluoromethyl, difluoromethyl, trifluoromethyl, tetrafluoromethyl, fluoroethyl, 1,1-difluoroethyl, 1,2-difluoroethyl, 1-fluoropropyl, 2-fluoropropyl, 1-fluorovinyl, 1-fluoropropenyl, 2-fluoropropenyl, 1-fluoroethynyl, 1-fluoropropynyl, or 2-fluoropropynyl.

In a preferred embodiment, the fluorinated co-solvent represented by Formula I is ethyl 2-fluoropropionate, 2-fluoroethyl propionate, ethyl 3-fluoropropionate, ethyl heptafluorobutanoate, 2,2-difluoroethyl acetate, 2,2,2-trifluoroethyl acetate, methyl difluoroacetate, ethyl-difluoroacetate, ethyl trifluoroacetate, methyl-3,3,3-trifluoropanoate, or a combination thereof.

In a more preferred embodiment, the fluorinated co-solvent represented by Formula I is ethyl 2-fluoropropionate:

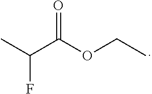

In a preferred embodiment, the fluorinated co-solvent represented by Formula II is 1,1-difluoro-2-(2-methoxyethoxy) ethane, 1,1,1-trifluoro-2-(2-methoxyethoxy) ethane, 1-(2,2-difluoroethoxy)-3-methoxypropane, 1-(2,2-difluoroethoxy)-3-ethoxypropane, 2-(2-ethoxyethoxy)-1,1-difluoroethane, 2-methyl-2-[2-(2,2,2-trifluoroethoxy) ethoxy]propane, 1,1-difluoro-2-(2-(2-methoxyethoxy) ethoxy) ethane, 1, 1,1-trifluoro-2-(2-(2-methoxyethoxy) ethoxy) ethane, 2-(2-(2,2-difluoroethoxy) ethoxy)-2-methylpropane, or a combination thereof.

In a more preferred embodiment, the fluorinated co-solvent represented by Formula II is 1,1-difluoro-2-(2-methoxyethoxy) ethane:

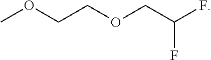

In a preferred embodiment, the fluorinated co-solvent represented by Formula III is 2-fluoroacetonitrile, 3-fluoropropanenitrile, or a combination thereof.

The inventors of the present disclosure found that ionic conductivity and solvation shell of the lithium ion can be optimized via selecting the structure of the fluorinated co-solvent.

It is worthy noted that the fluorinated co-solvents represented by any one of Formulae I-III possess 1~30 kcal/mol decrement of calculated de-solvation energy compared to the non-fluorinated solvents, and a high ionic conductivity of 8-25 mS/cm comparable to the carbonate-based electrolyte. This means that the de-solvation energy of the lithium ion can be decreased, while maintaining the ionic conductivity, and thus the fast-charging ability can be increased.

In the context of the present disclosure, the unsaturated siloxane, the saturated siloxane and/or the triazine compound is used as a scavenger (e.g., a FEC-compatible scavenger) in a non-aqueous electrolyte for a lithium-ion battery, to scavenge trace water and HF generated by the side reaction under high temperature in a non-aqueous electrolyte.

In a particular embodiment, the unsaturated siloxane, the saturated siloxane and/or the triazine compound may be 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9 or 2.0 wt % or in any range composed of the above numbers, with respect to the total weight of the non-aqueous electrolyte.

In a preferred embodiment, the unsaturated siloxane, the saturated siloxane and/or the triazine compound may be 0.5-1 wt %, with respect to the total weight of the non-aqueous electrolyte.

In a further embodiment, the unsaturated siloxane is represented by formula IV:

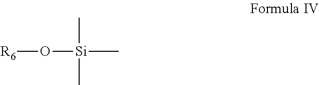

wherein R₆ is a C2-C4 hydrocarbyl group with at least one unsaturated carbon-carbon double or triple bond.

In the context of the present disclosure, the term “C2-C4 hydrocarbyl group with at least one unsaturated carbon-carbon double or triple bond” refers to an unsaturated hydrocarbyl group having 2, 3 or 4 carbon atoms, and may be, for example, but is not limited to, vinyl, propenyl, butenyl, isobutenyl, ethynyl, propynyl, or butynyl.

In a preferred embodiment, the unsaturated siloxane represented by Formula IV may be propargyloxy trimethylsilane (PMSL).

In a further embodiment, the saturated siloxane is represented by any one of formulae V and VI:

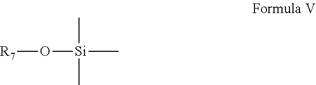

wherein R₇ is a C1-C6 saturated hydrocarbyl group;

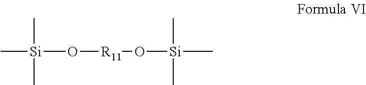

wherein R₁₁ is an optionally substituted C1-C6 alkylene group.

As used herein, the term “C1-C6 saturated hydrocarbyl group” refers to a hydrocarbyl group which has 1-6 (e.g., 1, 2, 3, 4, 5 or 6) carbon atoms and has no any carbon-carbon double or triple bond.

As used herein, the term “optionally substituted C1-C6 alkylene group” refers to an alkylene which has 1-6 (e.g., 1, 2, 3, 4, 5 or 6) carbon atoms and is unsubstituted or substituted with one or more substituents such as cyano group(s).

In a particular embodiment, the saturated siloxane represented by formula V is trimethyl(alkoxy) silane. In a more particular embodiment, trimethyl(alkoxy) silane may be trimethyl(methoxy) silane, trimethyl(ethoxy) silane, trimethyl(propoxy) silane (TMSL), trimethyl(butoxy) silane, trimethyl(pentoxy) silane and trimethyl(hexoxy) silane.

In a particular embodiment, the saturated siloxane represented by formula VI may be 2,2,7,7-tetramethyl-3,6-dioxa-2,7-disilaoctane-4,4,5,5-tetracarbonitrile (TDSTCN).

In a further embodiment, the triazine compound is represented by formula VII:

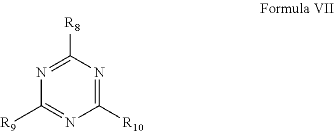

wherein R₈, R₉ and R₁₀ are each independently a C1-C4 hydrocarbyl group.

In the context of the present disclosure, the term “C1-C4 hydrocarbyl group” is defined as mentioned above. In a particular embodiment, the triazine compound may be triallyl cyanurate (TAC), but is not limited thereto.

A traditional electrolyte comprises fluoroethylene carbonate (also known as 4-fluoro-1,3-dioxolan-2-one, FEC) as a film-forming additive. Since the large expansion nature of silicon anode, FEC is essential in the electrolyte to maintain the solid electrolyte interface (SEI) on silicon particles. Still, its side reaction under high temperature will generate HF, damaging the interphase and boosting electrolyte decomposition. Thus, the scavenger is a common ingredient in the electrolyte for silicon anode. However, traditional scavenger materials, such as tris(trimethylsilyl) phosphate (TMSP) and tris(trimethylsilyl) borate (TMSB), can accelerate the side reaction of FEC. The inventors of the present disclosure found that the unsaturated siloxane represented by Formula IV, e.g., PMSL, the saturated siloxane represented by Formula V or VI, e.g., TMSL or TDSTCN, and the triazine compound represented by VII, e.g., triallyl cyanurate (TAC), when used alone or in combination with each other, are FEC-compatible and can scavenge trace water and HF generated by FEC side reaction.

The inventors of the present disclosure further found that an alternative film-forming additive di-fluoroethylene carbonate (also known as 4,5-difluoro-1,3-dioxolan-2-one, DiFEC) can repair SEI by replacing FEC partially. The adoption of combined film-forming additives, e.g., FEC plus DiFEC, and a scavenger, e.g., PMSL, can stabilize the electrolyte composition and the SEI interphase.

In a particular embodiment, the combination of fluoroethylene carbonate and di-fluoroethylene carbonate may be 1.0, 1.1, 1.2, 1.3, 1.4, 1.5, 1.6, 1.7, 1.8, 1.9, 2.0, 2.5, 3.0, 3.5, 4.0, 4.5, 5.0, 5.5, 6.0, 6.5, 7.0, 7.5, 8.0, 8.5, 9.0, 9.5, 10, 10.5, 11.0, 11.5, 12.0, 12.5, 13.0, 13.5, 14.0, 14.5 or 15 wt % or in any range composed of the above numbers, with respect to the total weight of the non-aqueous electrolyte.

In a preferred embodiment, the combination of fluoroethylene carbonate and di-fluoroethylene carbonate may be 5-10 wt %, with respect to the total weight of the non-aqueous electrolyte.

In a further particular embodiment, the fluoroethylene carbonate and the di-fluoroethylene carbonate is in a weight ratio of 10:1 to 1:1. For example, the fluoroethylene carbonate and the di-fluoroethylene carbonate may in a weight ratio of 10:1, 9:1, 8:1, 7:1, 6:1, 5:1, 4:1, 3:1, 2:1 or 1:1 or in any range composed of the above numbers.

In a further preferred embodiment, the fluoroethylene carbonate and the di-fluoroethylene carbonate is in a weight ratio of 2:1 to 1:1.

In another particular embodiment, the non-aqueous electrolyte further comprises:
(4) 10-20 wt % of a lithium salt, selected from lithium hexafluorophosphate (LiPF₆), lithium bis(fluorosulfonyl)imide (LiFSI), lithium bis(trifluoromethylsulfonyl)imide (LiTFSI), lithium tetrafluoroborate (LiBF₄) or a combination thereof; and
(5) 10-80 wt % of a carbonate solvent, selected from ethylene carbonate, ethyl methyl carbonate, dimethyl carbonate, diethyl carbonate, propylene carbonate or a combination thereof.

In a particular embodiment, the carbonate solvent and fluorinated co-solvent is in a weight ratio of 1:1 to 3:1. For example, the carbonate solvent and fluorinated co-solvent may be in a weight ratio of 1:1, 1.5:1, 2:1, 2.5:1 or 3:1 or in any range composed of the above numbers.

In a preferred embodiment, the carbonate solvent and the fluorinated co-solvent is in a weight ratio of 3:1. The inventors of the present disclosure found that an optimal ratio of the carbonate solvent and the fluorinated co-solvent can improve the high-rate capacity of the electrolyte.

In another particular embodiment, the non-aqueous electrolyte is used for a silicon-based anode in the lithium-ion battery. Said silicon-based anode may be the anode fabricated by silicon-oxygen or silicon-carbon material. Said silicon-oxygen material may be SiOₓ wherein x is 0-2. Said silicon-carbon material may be a mixture of (1) Si and/or SiOₓ wherein x is 0-2 and (2) graphite. In a particular embodiment, x may be 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9 or 2.0.

As mentioned above, because of the combination of the fluorinated co-solvents, the siloxane (unsaturated and/or saturated) and/or the triazine compound with di-fluoroethylene carbonate, in the non-aqueous electrolyte, the lithium-ion battery of the present disclosure shows a high thermal stability and fast-charging ability.

In a second aspect of the present disclosure, provided is use of an unsaturated siloxane, a saturated siloxane and/or a triazine compound as a scavenger in a non-aqueous electrolyte for a lithium-ion battery, wherein, the unsaturated siloxane is represented by formula IV:

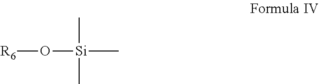

wherein R₆ is a C2-C4 hydrocarbyl group with at least one unsaturated carbon-carbon double or triple bond;
the saturated siloxane is represented by any one of formulae V and VI:

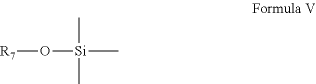

wherein R₇ is a C1-C6 saturated hydrocarbyl group;

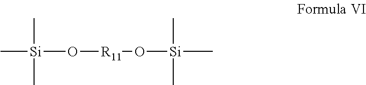

wherein R₁₁ is an optionally substituted C1-C6 alkylene group; and
the triazine compound is represented by formula VII:

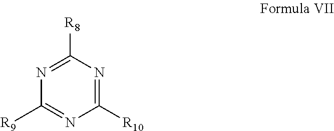

wherein R₈, R₉ and R₁₀ are each independently a C1-C4 hydrocarbyl group.

Regarding the definition of the groups in the formulae, reference can be made to the above content in connection with the composition.

In a particular embodiment, the unsaturated siloxane represented by formula IV is propargyloxy trimethylsilane (PMSL).

In another particular embodiment, the saturated siloxane represented by any one of formulae V and VI is trimethyl(alkoxy) silane or 2,2,7,7-tetramethyl-3,6-dioxa-2,7-disilaoctane-4,4,5,5-tetracarbonitrile (TDSTCN). In particular, trimethyl(alkoxy) silane comprises trimethyl(methoxy) silane, trimethyl(ethoxy) silane, trimethyl(propoxy) silane, trimethyl(butoxy) silane, trimethyl(pentoxy) silane and trimethyl(hexoxy) silane, but is not limited thereto.

In a particular embodiment, the unsaturated siloxane, a saturated siloxane and/or the triazine compound may be 0.1-2%, e.g., 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9 or 2.0 wt %, or in any range composed of the above numbers, with respect to the total weight of the non-aqueous electrolyte.

In a preferred embodiment, the unsaturated siloxane, the saturated siloxane and/or the triazine compound may be 0.5-1 wt %, with respect to the total weight of the non-aqueous electrolyte.

The inventors of the present disclosure found the unsaturated siloxane, the saturated siloxane and/or the triazine compound as defined above, when used alone or in combination with each other, are/is a FEC-compatible scavenger and can scavenge water and HF generated in the non-aqueous electrolyte.

In a further particular embodiment, the unsaturated siloxane, the saturated siloxane and/or the triazine compound as defined above is used in the non-aqueous electrolyte for a silicon-based anode in the lithium-ion battery. Said silicon-based anode may be the anode fabricated by silicon-oxygen or silicon-carbon material. Said silicon-oxygen material may be SiOₓ wherein x is 0-2. Said silicon-carbon material may be a mixture of (1) Si and/or SiOₓ wherein x is 0-2 and (2) graphite. In a particular embodiment, x may be 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9 or 2.0.

### EXAMPLES

Within this specification, examples have been described in a way which enables a clear and concise specification to be written, but it is intended and will be appreciated that examples may be variously combined or separated without parting from the disclosure. For example, it will be appreciated that all preferred features described herein are applicable to all aspects of the disclosure described herein.

### Example 1: Preparation of Non-Aqueous Electrolytes

The non-aqueous electrolytes were prepared according to the followings steps and the components and weights given in the following Table 1.

The weight of each component required for a certain amount of the non-aqueous electrolyte was calculated according to its weight ratio. First, the solvents of ethylene carbonate and ethyl methyl carbonate were mixed with or without the co-solvent of ethyl 2-fluoropropionate, 1,1-difluoro-2-(2-methoxyethoxy) ethane, or 2-fluoroacetonitrile. Then the weighted LiPF₆ and LiFSI were dissolved in the mixed solvents under an Ar-filled glovebox environment with O₂<0.5 ppm and H₂O<0.5 ppm. Subsequently, the film-forming additives of fluoroethylene carbonate and di-fluoroethylene carbonate, and the scavenger of propargyloxy trimethylsilane, trimethyl(propoxy) silane (TMSL), triallyl cyanurate (TAC), 2,2,7,7-tetramethyl-3,6-dioxa-2,7-disilaoctane-4,4,5,5-tetracarbonitrile (TDSTCN) or tris(trimethysilyl) phosphate were added to obtain the electrolytes.

TABLE 1
Examples (Exp.) and Comparative Examples (Comp.) of the non-aqueous
electrolytes (in wt %)

| | | Exp. | Exp. | Exp. | Exp. | Exp. | Exp. | Exp. | Exp. | Comp. | Comp. | Comp. | Comp. |
|---|---|---|---|---|---|---|---|---|---|---|---|---|---|
| Components | | 1 | 2 | 3 | 4 | 5 | 6 | 7 | 8 | 1 | 2 | 3 | 4 |
| Ethyl 2-fluoropropionate | | 20% | 5% | 30% | — | — | 20% | 30% | 20% | 20% | — | 20% | 20% |
| 1,1-Difluoro-2-(2- | | — | — | — | 20% | — | — | — | — | — | — | — | — |
| methoxyethoxy)ethane | | | | | | | | | | | | | |
| 2-fluoroacetonitrile | | — | — | — | — | 20% | — | — | — | — | — | — | — |
| Film- | Fluoroethylene | 5% | 5% | 5% | 5% | 5% | 5% | 5% | 5% | 5% | 5% | 5% | 5% |
| forming | carbonate (FEC) | | | | | | | | | | | | |
| additive | di-fluoroethylene | 5% | 5% | 5% | 5% | 5% | 5% | 5% | 5% | — | — | 5% | 5% |
| | carbonate (DiFEC) | | | | | | | | | | | | |
| Sca- | propargyloxy | 0.5% | 0.5% | 05% | 0.5% | 0.5% | — | — | — | 0.5% | 0.5% | — | — |
| venger | trimethylsilane (PMSL) | | | | | | | | | | | | |
| | trimethyl(propoxy)silane | — | — | — | — | — | 0.5% | — | — | — | — | — | — |
| | (TMSL) | | | | | | | | | | | | |
| | triallyl cyanurate (TAC) | — | — | — | — | — | — | 0.5% | — | — | — | — | — |
| | 2,2,7,7-tetramethyl-3,6- | — | — | — | — | — | — | — | 0.5% | — | — | — | — |
| | dioxa-2,7- | | | | | | | | | | | | |
| | disilaoctane-4,4,5- | | | | | | | | | | | | |
| | tetracarbonitrile | | | | | | | | | | | | |
| | (TDSTCN) | | | | | | | | | | | | |
| | tris (trimethylsilyl) | — | — | — | — | — | — | — | — | — | — | 0.5% | — |
| | phosphate | | | | | | | | | | | | |
| Lithium | LiPF₆ | 7% | 7% | 7% | 7% | 7% | 7% | 7% | 7% | 7% | 7% | 7% | 7% |
| salts | LiFSI | 7% | 7% | 7% | 7% | 7% | 7% | 7% | 7% | 7% | 7% | 7% | 7% |
| Car- | ethylene carbonate | 20% | 20% | 20% | 20% | 20% | 20% | 20% | 20% | 20% | 20% | 20% | 20% |
| bonate | ethyl methyl | 35.5% | 50.5% | 25.5% | 35.5% | 35.5% | 35.5% | 35.5% | 35.5% | 40.5% | 60.5% | 35.5% | 36% |
| Solvent | carbonate | | | | | | | | | | | | |

### Example 2: Aging Tests of the Non-Aqueous Electrolytes

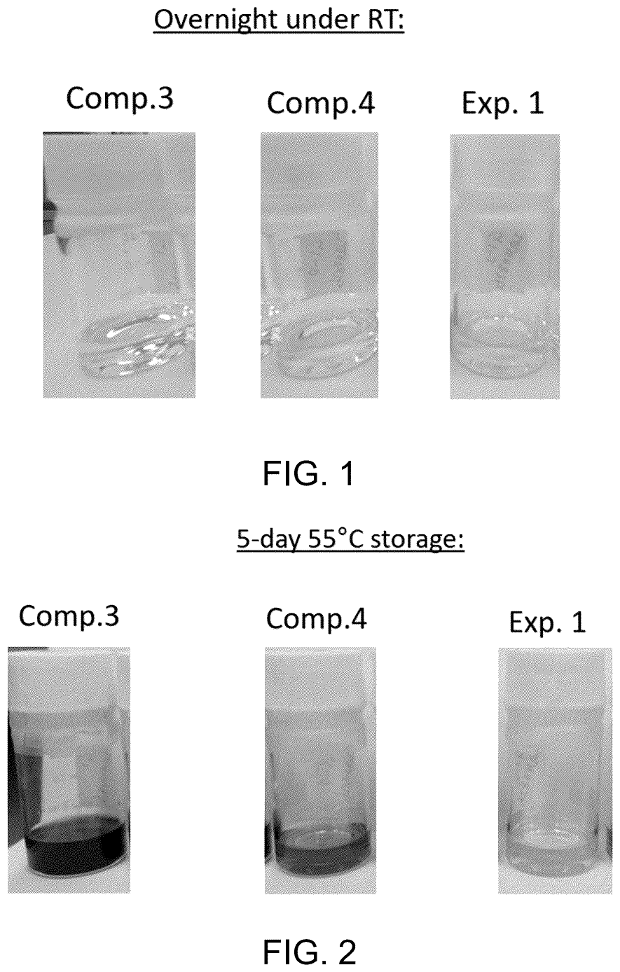

The non-aqueous electrolytes of Exp. 1, Comp. 3 and Comp. 4 were firstly placed at room temperature overnight. The results are shown in FIG. 1. It can be seen that the three non-aqueous electrolytes show no color change, indicating no decomposition of the electrolytes at the beginning.

Secondly, the non-aqueous electrolytes of Exp. 1, Comp. 3 and Comp. 4 were firstly placed at 55° C. for 5 days. The results are shown in FIG. 2. It can be seen that in Comp. 3, the conventional scavenger, tris(trimethylsilyl) phosphate, was not compatible with FEC in the current non-aqueous electrolyte system, resulting in an increase of acid generated from the electrolyte; in Comp. 4, which had no scavenger, color was also changed; in contrast, the non-aqueous electrolytes of Exp. 1 according to the present disclosure did not show color change with aging.

### Example 3: Preparation of Lab-Made Winding Pouch Cells

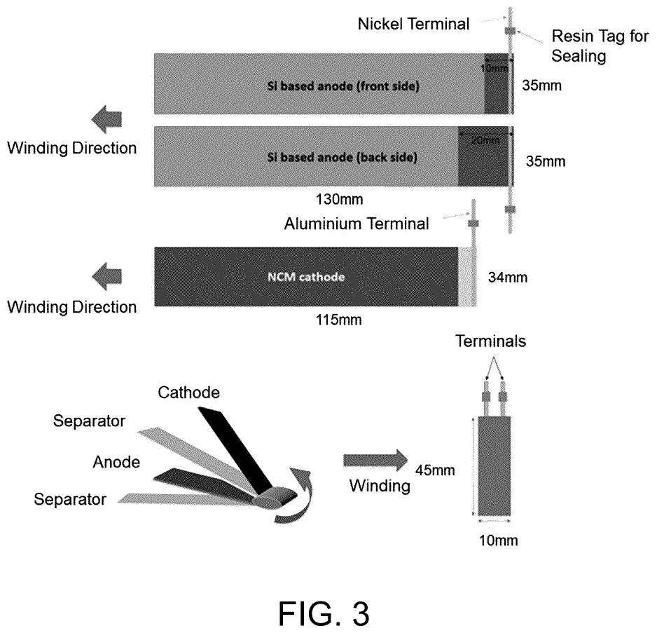

Winding pouch cells with a capacity of around 200 mAh were prepared to examine the state of health (SOH) of the electrolytes after storage. The dry pouch cell was prepared first, which consisted of an electrode pair, each welded with a metal terminal, a polymer separator with ceramic coating on the cathode side, and laminated aluminum foil packaging. The electrode pair and the separator were wound into a roll before being sealed in the laminated foil casing. FIG. 3 illustrates the structures of the lab-made winding pouch cells. The anode was graphite mixed with SiOx (x is 0.7-1.3), presenting an areal capacity of 4.3 mAh/cm²; the cathode was NCM811 with a 3.9 mAh/cm² areal capacity. Second, 0.4 g electrolytes as shown in Table 1 of Example 1 were added to the dry cell and rest for 48 h to ensure the wetting of the electrodes and separator before sealing. Then, the sealed cells were constant-current (CC) charged in three steps: 0.02C to 3.0 V; 0.05C to 3.4 V; 0.33C to 3.8 V. Subsequently, the cells were stored under 45° C. for 24 h, followed by 2^{nd}-sealing to remove the gas generated during the above formation process. Third, the cell capacity was determined by three charge-discharge cycles with 0.33C constant-current followed by constant-voltage (CCCV) charging and 0.33C CC discharging in the range of 2.75 V to 4.25 V.

### Example 4: Tests for State of Health of the Non-Aqueous Electrolytes

The non-aqueous electrolytes of Exp. 1, Exp. 6, Exp. 7, Exp. 8, Comp. 3 and Comp. 4 were tested for state of health (SOH) after storage at 55° C. for 30 days.

The initial capacity of the cells prepared in Example 3 using the electrolytes as listed in Table 1 was examined by the aforementioned 0.33C CCCV charging and 0.33C CC discharging cycles. Then the cells were fully charged to 100% State of Charge (SOC) by 0.33C CCCV before the thermal storage. After 55° C. storage for 30 days, the cells were cooled down at room temperature for 8 h. Then the capacity retention was measured by 0.33C CC discharge, followed by a 0.33C/0.33C CCCV-CC charge-discharge cycle for evaluating the capacity recovery.

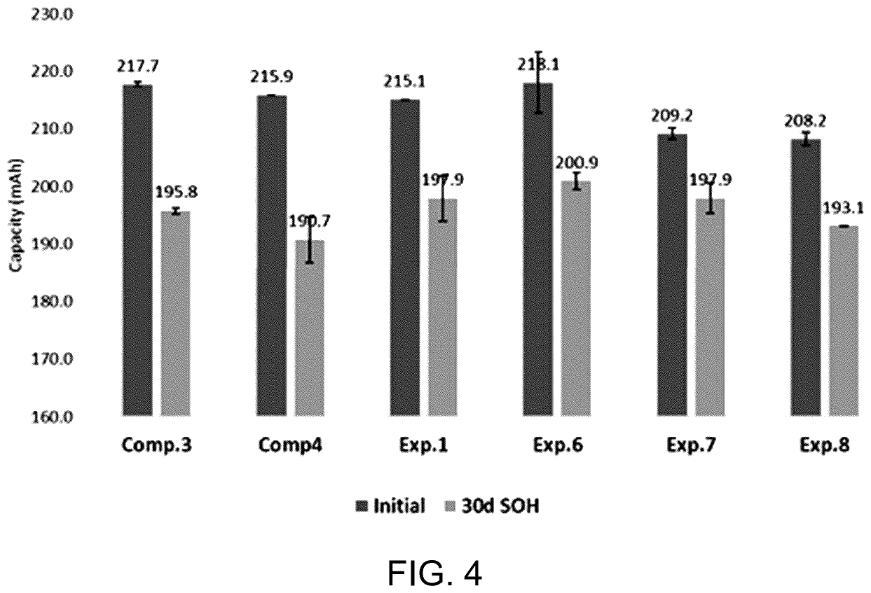

The results of the cell capacities for the cells with the electrolytes of Exp. 1, Exp. 6, Exp. 7, Exp. 8, Comp. 3 and Comp. 4 are shown in FIG. 4. It can be seen that the cell with the electrolyte of Exp. 1, Exp. 6, Exp. 7, Exp. 8 remained at least 92% of the initial capacity even after 30-day storage at 55° C., which means PMSL/TMSL/TAC/TDSTCN as a scavenger can effectively maintain the state of health of the non-aqueous electrolytes.

As above, the non-aqueous electrolytes according to the present disclosure show an improved high thermal stability.

### Example 5: Tests for Ionic Conductivity and De-Solvation Energy

Measurement of ionic conductivity: The ionic conductivity of the electrolytes was measured by the conductivity meter for liquids. The measured ionic conductivity results for Exp. 1~8 and Comp. 1&2 in Table 1 are shown in Table 2.

TABLE 2
Measured ionic conductivities of Exp. 1~8 and Comp. 1&2 in Table 1

| | Exp. | Exp. | Exp. | Exp. | Exp. | Exp. | Exp. | Exp. | Comp. | Comp. |
|---|---|---|---|---|---|---|---|---|---|---|
| Electrolytes | 1 | 2 | 3 | 4 | 5 | 6 | 7 | 8 | 1 | 2 |
| Ionic | 9.30 | 9.51 | 9.24 | 9.54 | 14.81 | 9.29 | 9.31 | 9.3 | 9.95 | 9.67 |
| conductivity(mS/cm) | | | | | | | | | | |

As can be seen from Table 2, the electrolytes of Exp. 1, Exp. 2, Exp. 3, Exp. 4, Exp. 5, Exp. 6, Exp. 7 and Exp. 8 have close or higher ionic conductivity as compared to the electrolytes of Comp. 1 and Comp. 2.

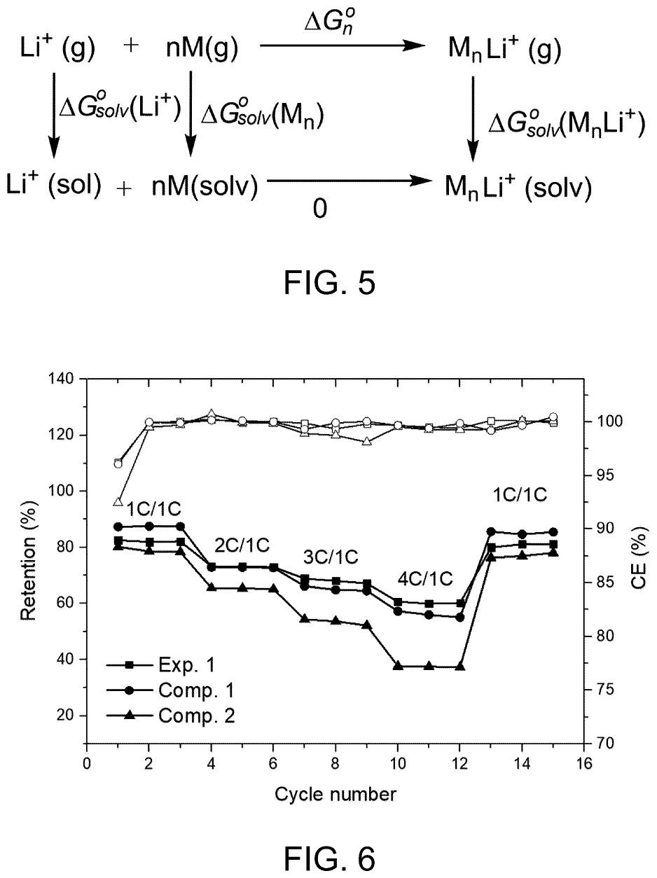

The de-solvation energy of electrolyte was evaluated by theoretical calculation:
1) Determination of the electrolyte de-solvation structure: The atom selection process was used in the RDF analysis part using the MD_analysis_atoms module. The rdf-workflow.py/RDF analysis molecule library involved contains all possible solvents and salts, and resname was also used for selection. For ease of processing, a setting was made for RDF analysis, using specific atoms in the molecule to represent the molecule; and in order to locate the molecule, the resid order was used for restriction. This part can be modified in dict to other resnames to further optimize the results.
2) Calculation of de-solvation energy: The conventional solvation free energy was calculated based on thermochemistry as shown in FIG. 5. All geometry optimization for gaseous phase was carried out at a relative low level using the B3LYP functional and 6-31+G (d) basis set, and the most stable conformers at this level for gas phase geometries were used for further single energy calculation based on extended basis (def2tzvp). The effect of a liquid surrounding was modeled using a solvation model based on density (SMD). The corresponding electronic energies in the solvent reaction fields were calculated at the M062X/6-31G (d) level. The vibration frequency was performed to make sure whether it is a minimum point with no imaginary frequency on the potential energy surfaces. All above calculations were carried out by the Gaussian 16 program.

To verify whether the calculated de-solvation energy is comparable to the measured de-solvation energy, the de-solvation energy of the electrolytes in Table 1 was measured experimentally using symmetric coin cells with two anodes. First, coin cells CR2032 were fabricated using cathode and anode with diameters of 12 mm and 14 mm, respectively, separated by PE with double-sided ceramic (10+2+2 μm). The cathode and anode material was the same as that of the pouch cells in Example 3. The added electrolyte was 60 μL for each cell. The formation followed the three CC charging steps as those in Example 3. Then the coin cells were charged to 50% State of Charge (SOC) after determining capacity. Second, the cells were disassembled in Ar-filled glovebox with <0.5 ppm O₂ and <0.5 ppm H₂O. Every two anodes of the disassembled cells were used for assembling the symmetric cells. Electrochemical Impedance Spectroscopy (EIS) of these symmetric cells was measured at a range of temperatures, −20° C., 0° C., 20° C. and 40° C., of which the charge transfer impedance, R_{ct}, was derived by fitting. The temperature and R_{ct} follows Arrhenius equation, which can calculate the activation energy of the charge transfer process, which is approximately equal to the de-solvation energy.

The calculated de-solvation energy of Exp. 1 is 2.5 kcal/mol lower than that of Comp. 2, following the trend of measured de-solvation energies of Exp. 1 and Comp. 2 (0.614 kJ/mol and 1.949 kJ/mol, respectively). As can be seen from the results of the calculated and measured de-solvation energies, the calculated de-solvation energy was comparable to the measured de-solvation energy, which means that the calculated de-solvation energy by the calculation method according to the present disclosure is reliable and can be used to evaluate the fast-charging performance of the cells. The de-solvation energy calculation results indicate that, as compared to the prior-art cells, the cells according to the present disclosure showed a lower de-solvation energy, which may achieve a better fast-charging performance where the cells have close or higher ionic conductivity as shown in Table 2.

### Example 6: Tests for Fast-Charging Performance

Firstly, the lab-made winding pouch cells were fabricated by the process in Example 3 except that the cell capacity was around 1 Ah.

The fast-charging performance of the lab-made winding pouch cells with a cell capacity of around 1 Ah is represented by the C-rate performance, measured by the battery tester (5V, 6A), where the CC charging processes varied from 1C, 2C, 3C to 4C (i.e. 1A, 2A, 3A and 4A), and then back to 1C, while the CC discharge processes maintained at 1C (1A). The capacities at different charging rates were used to evaluate the fast-charging ability of the electrolyte, especially the 4C charging capacity.

To demonstrate the role of ethyl 2-fluoropropionate and DiFEC in facilitating the fast charging performance, as compared to the electrolyte of Exp. 1, the electrolyte of Comp. 1 was designed to comprise ethyl 2-fluoropropionate but without DiFEC, and the electrolyte of Comp. 2 was designed to comprise no ethyl 2-fluoropropionate or DiFEC. The results of the fast-charging performance of the electrolytes of Exp. 1, Comp. 1 and Comp. 2 are shown in FIG. 6. It can be seen from FIG. 6 that the cell with the electrolyte of Exp. 1, in which ethyl methyl carbonate was partly replaced by the fluorinated solvent, i.e., ethyl 2-fluoropropionate and DiFEC was comprised as a film-forming additive, showed much higher charging capacity at 4C charging, which was 61% as compared to that of the 0.33C charging rate. However, the cell with the electrolyte of Comp. 2 showed the achievement of 37.5% capacity at 4C charging. The electrolyte of Comp. 1 comprising ethyl 2-fluoropropionate but no DiFEC showed the 4C charging capacity of 55.9%. These two electrolytes (Comp. 1 and Comp. 2) showed very similar ionic conductivity, but quite different de-solvation energy, which may be due to the presence of the filming forming additives in Comp. 1.

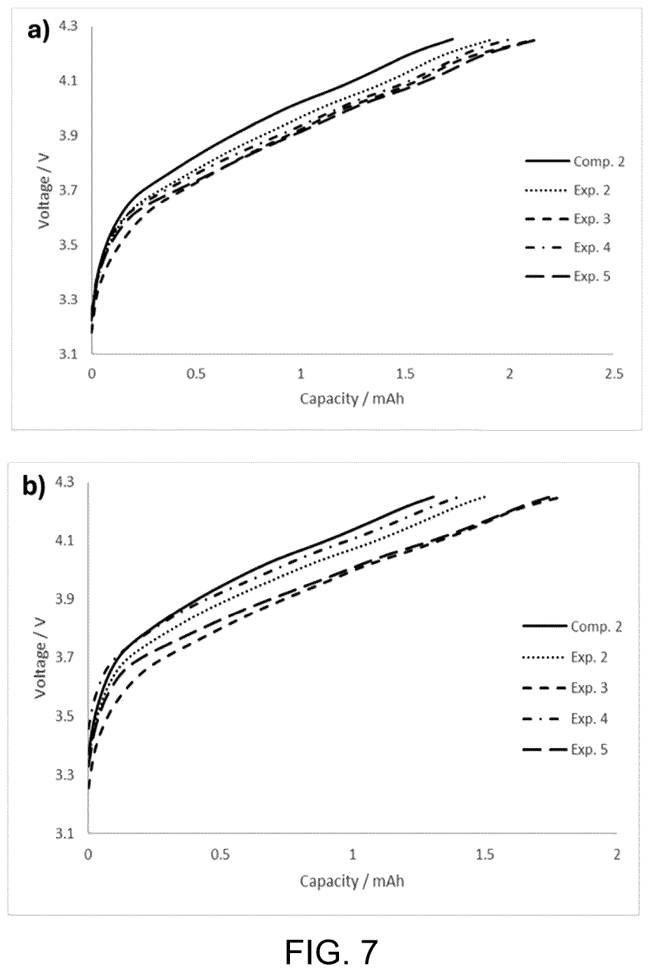

Additionally, the CR2032 coin cells were fabricated as Example 5 with a capacity of 3 mAh using the different electrolytes of Exp. 2, Exp. 3, Exp. 4, Exp. 5 and Comp. 2. Fast charging capacities at 3C and 4C were compared in FIGS. 7a and 7b, respectively, where the electrolytes with fluorinated co-solvents presented higher capacities than Comp. 2.

The test results indicate that the cells, which have close or higher ionic conductivity as shown in Table 2 and a lower de-solvation energy, can achieve a better fast-charging performance.

### Example 7: Tests for Solid Electrolyte Interface (SEI)

The SEI of the anodes using different electrolytes in Table 1 of cells were etched by ion beam etching and characterized by X-ray photoelectron spectroscopy (XPS) after formation.

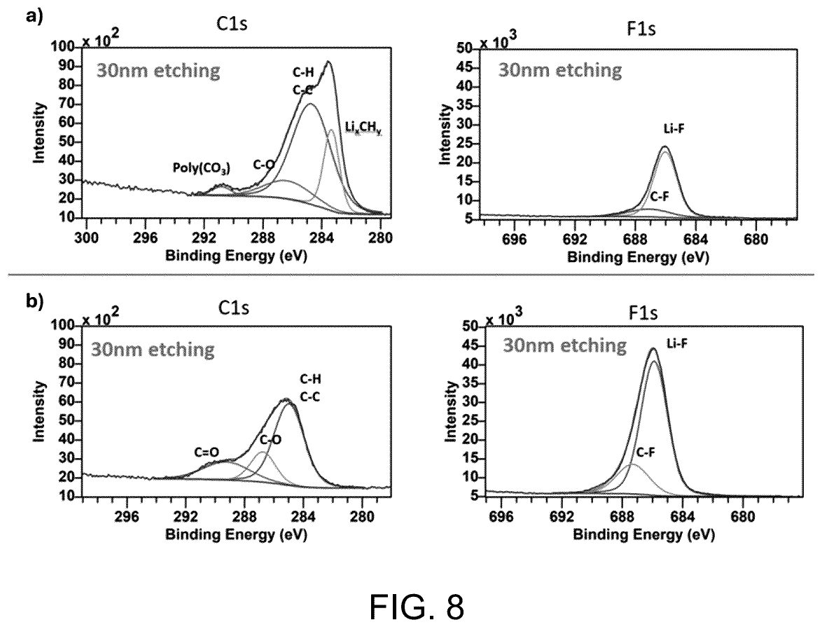

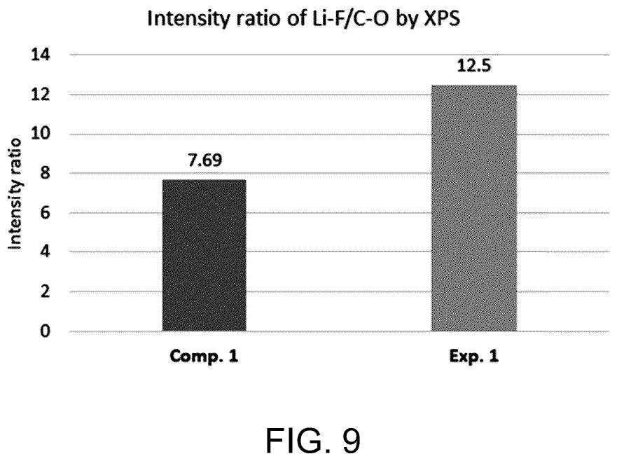

The results are given in FIGS. 8 and 9. It can be found that the SEI of cell using electrolyte of Exp. 1, which comprised DiFEC, showed a higher intensity ratio of inorganic component (LiF intensity by XPS, at 686-687 nm) over organic component (C—O intensity by XPS, at 286-287 nm), as compared to the SEI of cell using electrolyte of Comp. 1. The SEI with a higher inorganic component can improve the Li ion diffusion, the film-forming additive DiFEC can decomposed during the formation process and generate the LiF-rich SEI to improve the battery charging performance.

Those skilled in the art, in light of the present disclosure, will appreciate that many changes can be made in the specific embodiments which are disclosed herein and still obtain alike or similar result without departing from or exceeding the spirit or scope of the disclosure. One skilled in the art will further understand that any properties reported herein represent properties that are routinely measured and may be obtained by multiple different methods. The methods described herein represent one such method and other methods may be utilized without exceeding the scope of the present disclosure.

The foregoing description of various forms of the disclosure has been presented for purposes of illustration and description. It is not intended to be exhaustive or to limit the disclosure to the precise forms disclosed. Numerous modifications or variations are possible in light of the above teachings. The forms discussed were chosen and described to provide the best illustration of the principles of the disclosure and its practical application to thereby enable one of ordinary skill in the art to utilize the disclosure in various forms and with various modifications as are suited to the particular use contemplated. All such modifications and variations are within the scope of the disclosure as determined by the appended claims when interpreted in accordance with the breadth to which they are fairly, legally, and equitably entitled.

What is claimed is:

1. A lithium-ion battery comprising a non-aqueous electrolyte, wherein the non-aqueous electrolyte comprises:
(1) 5-30 wt % of a fluorinated co-solvent;
(2) 0.1-2 wt % of an unsaturated siloxane, a saturated siloxane and/or a triazine compound; and
(3) 1-15 wt % of a combination of fluoroethylene carbonate and di-fluoroethylene carbonate as a film-forming additive.

2. The lithium-ion battery of claim 1, wherein the fluorinated co-solvent is selected from a compound represented by any one of Formulae I-III: 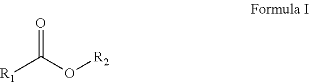
wherein R₁ is a C1-C4 hydrocarbyl or fluorohydrocarbyl group; R₂ is a C1-C4 hydrocarbyl or fluorohydrocarbyl group; and at least one of R₁ and R₂ contains a fluorine atom; 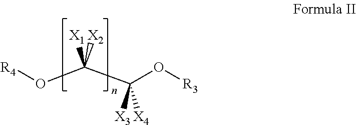
wherein n is any integer from 1 to 4, R₃ is a C1-C4 hydrocarbyl or fluorohydrocarbyl group; R₄ is a C1-C3 hydrocarbyl or fluorohydrocarbyl group, and at least one of R₃ and R₄ contains a fluorine atom; X₁ to X₄ are independently selected from hydrogen, halogen, or C1-C3 hydrocarbyl or fluorohydrocarbyl group; 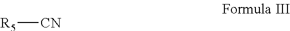
wherein R₅ is a C1-C4 fluorohydrocarbyl group.

3. The lithium-ion battery of claim 2, wherein the fluorinated co-solvent represented by Formula I is ethyl 2-fluoropropionate, 2-fluoroethyl propionate, ethyl 3-fluoropropionate, ethyl heptafluorobutanoate, 2,2-difluoroethyl acetate, 2,2,2-trifluoroethyl acetate, methyl difluoroacetate, ethyl-difluoroacetate, ethyl trifluoroacetate, methyl-3,3,3-trifluoropanoate, or a combination thereof.

4. The lithium-ion battery of claim 2, wherein the fluorinated co-solvent represented by Formula II is 1,1-difluoro-2-(2-methoxyethoxy) ethane, 1,1,1-trifluoro-2-(2-methoxyethoxy) ethane, 1-(2,2-difluoroethoxy)-3-methoxypropane, 1-(2,2-difluoroethoxy)-3-ethoxypropane, 2-(2-ethoxyethoxy)-1,1-difluoroethane, 2-Methyl-2-[2-(2,2,2-trifluoroethoxy) ethoxy]propane, 1,1-difluoro-2-(2-(2-methoxyethoxy) ethoxy) ethane, 1,1,1-trifluoro-2-(2-(2-methoxyethoxy) ethoxy) ethane, 2-(2-(2,2-difluoroethoxy) ethoxy)-2-methylpropane, or a combination thereof.

5. The lithium-ion battery of claim 2, wherein the fluorinated co-solvent represented by Formula III is 2-fluoroacetonitrile, 3-fluoropropanenitrile, or a combination thereof.

6. The lithium-ion battery of claim 1, wherein,
the unsaturated siloxane is represented by formula IV: 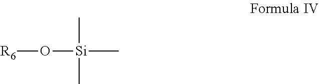
wherein R₆ is a C2-C4 hydrocarbyl group with at least one unsaturated carbon-carbon double or triple bond;
the saturated siloxane is represented by any one of formulae V and VI: 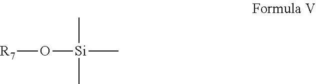
wherein R₇ is a C1-C6 saturated hydrocarbyl group; 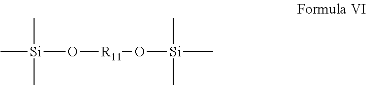
wherein R₁₁ is an optionally substituted C1-C6 alkylene group; and
the triazine compound is represented by formula VII: 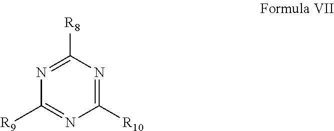
wherein R₈, R₉ and R₁₀ are each independently a C1-C4 hydrocarbyl group.

7. The lithium-ion battery of claim 6, wherein the unsaturated siloxane represented by Formula IV is propargyloxy trimethylsilane.

8. The lithium-ion battery of claim 6, wherein the saturated siloxane represented by any one of formulae V and VI is trimethyl(alkoxy) silane or 2,2,7,7-tetramethyl-3,6-dioxa-2,7-disilaoctane-4,4,5,5-tetracarbonitrile (TDSTCN), and the triazine compound represented by formula VII is triallyl cyanurate (TAC).

9. The lithium-ion battery of claim 8, wherein trimethyl(alkoxy) silane is selected from trimethyl(methoxy) silane, trimethyl(ethoxy) silane, trimethyl(propoxy) silane, trimethyl(butoxy) silane, trimethyl(pentoxy) silane and trimethyl(hexoxy) silane.

10. The lithium-ion battery of claim 1, wherein the fluoroethylene carbonate and the di-fluoroethylene carbonate is in a weight ratio of 10:1 to 1:1, preferably in a weight ratio of 2:1 to 1:1.

11. The lithium-ion battery of claim 1, wherein the non-aqueous electrolyte further comprises:
(4) 10-20 wt % of a lithium salt, selected from lithium hexafluorophosphate (LiPF₆), lithium bis(fluorosulfonyl)imide (LiFSI), lithium bis(trifluoromethylsulfonyl)imide (LiTFSI), lithium tetrafluoroborate (LiBF₄) or a combination thereof; and
(5) 10-80 wt % of a carbonate solvent, selected from ethylene carbonate, ethyl methyl carbonate, dimethyl carbonate, diethyl carbonate, propylene carbonate or a combination thereof.

12. The lithium-ion battery of claim 11, wherein the carbonate solvent and the fluorinated co-solvent is in a weight ratio of 1:1 to 3:1, preferably in a weight ratio of 3:1.

13. The lithium-ion battery of claim 1, wherein the non-aqueous electrolyte comprises:
(1) 15-25 wt % of a fluorinated co-solvent;
(2) 0.5-1 wt % of an unsaturated siloxane, a saturated siloxane and/or a triazine compound; and
(3) 5-10 wt % of a combination of fluoroethylene carbonate and di-fluoroethylene carbonate as a film-forming additive.

14. A method of using an unsaturated siloxane, a saturated siloxane and/or a triazine compound as a scavenger in a non-aqueous electrolyte for a lithium-ion battery, wherein, the unsaturated siloxane is represented by formula IV: 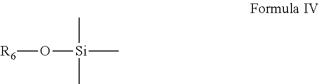
wherein R₆ is a C2-C4 hydrocarbyl group with at least one unsaturated carbon-carbon double or triple bond;
the saturated siloxane is represented by any one of formulae V and VI: 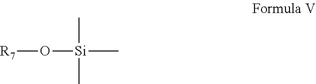
wherein R₇ is a C1-C6 saturated hydrocarbyl group; 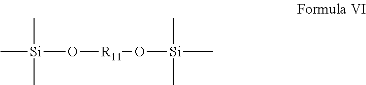
wherein R₁₁ is an optionally substituted C1-C6 alkylene group; and
the triazine compound is represented by formula VII: 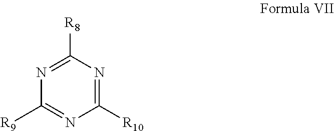
wherein R₈, R₉ and R₁₀ are each independently a C1-C4 hydrocarbyl group.

15. The method of claim 14, wherein the unsaturated siloxane represented by Formula IV is propargyloxy trimethylsilane.

16. The method of claim 14, wherein the saturated siloxane represented by any one of formulae V and VI is trimethyl(alkoxy) silane or 2,2,7,7-tetramethyl-3,6-dioxa-2,7-disilaoctane-4,4,5,5-tetracarbonitrile (TDSTCN), and the triazine compound represented by formula VII is triallyl cyanurate (TAC).

17. The method of claim 16, wherein the trimethyl(alkoxy) silane is selected from trimethyl(methoxy) silane, trimethyl(ethoxy) silane, trimethyl(propoxy) silane, trimethyl(butoxy) silane, trimethyl(pentoxy) silane and trimethyl(hexoxy) silane.

18. The method of claim 14, wherein the unsaturated siloxane, the saturated siloxane and/or the triazine compound is 0.1-2 wt %, preferably 0.5-1 wt %, in respect to total weight of the non-aqueous electrolyte.

19. The method of claim 14, wherein the unsaturated siloxane, the saturated siloxane and/or the triazine compound is used in the non-aqueous electrolyte for a silicon-based anode in the lithium-ion battery.
